(19) United States
(12) Patent Application Publication
(10) Pub. No.: US 2004/0236649 A1
(43) Pub. Date: Nov. 25, 2004

(54) Customer revenue prediction method and system

(75) Inventors: Patrick Yip, Morristown, NJ (US); Praveen Reddy, Jersey City, NJ (US)

Correspondence Address: McDERMOTT, WILL & EMERY, 600 13th Street, N.W., Washington, DC, 20005-3096, US

(73) Assignee: PERSHING INVESTMENTS, LLC

(21) Appl. No.: 10/851,164

(22) Filed: May 24, 2004

Related U.S. Application Data
(60) Provisional application No. 60/472,422, filed on May 22, 2003.
(60) Provisional application No. 60/472,412, filed on May 22, 2003.
(60) Provisional application No. 60/472,748, filed on May 23, 2003.
(60) Provisional application No. 60/472,747, filed on May 23, 2003.

(51) Int. Cl. G06F 17/60

(52) U.S. Cl. 705/30

(57) ABSTRACT

A method and system predict future revenue of an account or a customer associated therewith for a specific time period, such a month, a quarter, etc., based on past revenue. The technique uses historical revenue data of a predetermined number of time periods before the specific time period, to calculate the prediction revenue for the specific time period. Different weights are assigned to the revenue data of each of the predetermined number of time periods, wherein the weight is selected based on the recentness of each of the predetermined number of time periods relative to the specific time period. For instance, the revenue of a month closer to a month to be predicted is given more weight than older months. The weight for each time periods may be determined empirically, such as by regression. Prediction revenue of the specific time period is determined based on the historical revenue data and the weight of each of the predetermined number of time periods. The prediction revenue may be further adjusted to reflect growth rate.

### RELATED APPLICATIONS

This application claims the benefit of priority from the following U.S. Provisional Patent Applications: U.S. Provisional Patent Application Ser. No. 60/472,422, titled “CUSTOMER SCORING MODEL,” filed May 22, 2003, U.S. Provisional Patent Application Ser. No. 60/472,412, titled “LIFETIME REVENUE MODEL,” filed May 22, 2003; U.S. Provisional Patent Application Ser. No. 60/472,748, titled “FINANCE DATA MART ACCOUNT PROFITABILITY MODEL,” filed May 23, 2003; and U.S. Provisional Patent Application Ser. No. 60/472,747, titled “RATE INFORMATION MART ATTRITION ANALYSIS MODEL,” filed on May 23, 2003; and is related to U.S. patent application Ser. No. ______ (attorney docket 67389-037), titled “RATING SYSTEM AND METHOD FOR IDENTIFYING DESIRABLE CUSTOMERS,” filed concurrently herewith; U.S. patent application Ser. No. ______ (attorney docket 67389-039), titled “ACTIVITY-DRIVEN, CUSTOMER PROFITABILITY CALCULATION SYSTEM,” filed concurrently herewith; and U.S. patent application Ser. No. ______ (attorney docket 67389-040), titled “METHOD AND SYSTEM FOR PREDICTING ATTRITION CUSTOMERS,” filed concurrently herewith. Disclosures of the above-identified patent applications are incorporated herein by reference in their entireties.

### FIELD OF DISCLOSURE

This disclosure generally relates to a method and system for predicting revenue associated with customers or accounts, and more specifically, to a method and system that predict future revenue of a selected time period using historical revenue data with appropriate weights, and adjust the predicted revenue to reflect revenue growth and opportunity cost.

### BACKGROUND OF THE DISCLOSURE

A company usually desires customers who generate huge revenue or profit to the company. Thus, it is important for a company to be able to predict how much revenue or profit a customer may generate, and try to keep those customers who may generate large amount of revenue or profits to the company. It is economically sound for a company to provide better treatments and services to customers that generate more revenue or profits, such that those customers would continue to stay with the company.

Therefore, there is a need for a system or technique to predict revenue or profits that may be generated by customers. There is also a need to provide revenue predictions that reflect revenue growth or opportunity cost.

### SUMMARY OF THE DISCLOSURE

This disclosure presents a customer revenue prediction method and system that predict future revenue associated with an account or a customer associated with the account, based on historical revenue data related to the account. An exemplary revenue prediction system selects a specific time period, such as a month, a quarter, etc., for predicting revenue thereof. The system uses historical revenue data of a predetermined number of time periods prior to the specific time period, to calculate the prediction of revenue for the specific time period. Different weights are assigned to the revenue data of each of the prior time periods, wherein each weight is selected based on the recentness of each of the prior time periods relative to the specific time period. For instance, the revenue of a month closer to the month to be predicted is given more weight than older months. The weight for each time period may be determined empirically, such as by regression. Prediction revenue of the specific time period is determined based on the revenue data and the weight of each of the prior time periods.

In one embodiment, an exemplary revenue prediction system predicts revenue of a specific month based on revenue data of three or five months immediately before the predicted month. After prediction revenue for the predicted month is determined, the system may use the prediction revenue to predict revenue of the month next to the predicted month. For example, the system may predict revenue of June 2004 based on revenue of March, April and May, 2004 using the approach as described earlier. After the prediction revenue for June 2004 is determined, the prediction revenue may be used to predict revenue for July 2004. In this example, prediction revenue of July 2004 may be calculated based on known or predicted revenue of April, May and June 2004. In one embodiment, the system conducts the process repeatedly and calculates revenue for the next 12 months. The prediction revenue of the 12 months is accumulated to generate annual prediction revenue.

According to one embodiment, after prediction revenue for a specific period of time is determined, an exemplary revenue prediction system adjusts the prediction revenue by applying a predetermined adjustment rule to the prediction revenue. For instance, the system may adjust the prediction revenue by multiplying the prediction revenue by an appreciation or growth rate that reflects the natural growth of common stocks, and/or a discount rate that reflects the cost of capital or opportunity cost. According to another embodiment, the prediction revenue associated with an account is used to determine a service level of a customer associated with the account based on the prediction revenue associated with the account. The service level determines the type of treatments or services a customer associated with an account may receive. For instance, the service level may identify the priority to answer a phone call made by the customer, or a type of advertisement or information to be presented to the customer.

After the prediction revenue associated with an account is determined, a prediction of future profits associated with the account also may be determined. For instance, profits associated with an account may be calculated by subtracting an average annual expense from the projected annual revenue of the account. The average annual expense of the account may be determined by numerous known approaches, such as dividing the total expense associated with the account by the period of time the account has been existent.

A data processing system, such as a computer, may be used to implement the method and system as described herein. The data processing system may include a processor for processing data and a data storage device coupled to the processor, and a data transmission interface. The data storage device bears instructions to cause the data processing system upon execution of the instructions by the processor to perform functions as described herein. The instructions may be embodied in a machine-readable medium to control the data processing system to perform calculations and functions as described herein. The machine-readable medium may include any of a variety of storage media, examples of which include optical storage media, such as CD-ROM, DVD, etc., magnetic storage media including floppy disks or tapes, and/or solid state storage devices, such as memory card, flash ROM, etc. Such instructions may also be conveyed and transmitted using carrier wave type machine-readable media. Historical revenue data associated with a customer or account, and weight information may be stored in one or more databases implemented in the data storage device and/or any other data storage devices accessible by the data processing system, and may be transferred via a carrier medium through network communication.

Still other advantages of the presently disclosed methods and systems will become readily apparent from the following detailed description, simply by way of illustration and not limitation. As will be realized, the customer revenue prediction method and system are capable of other and different embodiments, and their several details are capable of modifications in various obvious respects, all without departing from the disclosure. Accordingly, the drawings and description are to be regarded as illustrative in nature, and not as restrictive.

### BRIEF DESCRIPTIONS OF THE DRAWINGS

The accompanying drawings, which are incorporated in and constitute a part of the specification, illustrate exemplary embodiments.

FIG. 1 is a schematic functional block diagram showing the operation of an exemplary customer revenue prediction system.

FIG. 2 shows a schematic block diagram of a data processing system upon which an exemplary customer revenue predication system may be implemented.

### DETAILED DESCRIPTIONS OF ILLUSTRATIVE EMBODIMENTS

In the following description, for the purposes of explanation, numerous specific details are set forth in order to provide a thorough understanding of the present subject matter. It will be apparent, however, to one skilled in the art that the present method and system may be practiced without these specific details. In other instances, well-known structures and devices are shown in block diagram form and described in summary functional terms in order to avoid unnecessarily obscuring the present disclosure.

For illustration purpose, the following descriptions discuss an exemplary customer revenue prediction method and system for use in a brokerage firm to predict revenue associated with one or more accounts, or one or more customers associated therewith. It is understood that the method and system disclosed herein may apply to many other types of industries or companies, and may have different variations, which are covered by the scope of this application.

For a brokerage firm, a customer or account may generate numerous types of income, such as trading revenue, fees, interest, etc. Trading revenue may include commissions for different types of transactions or equity trading. The brokerage firm may charge fees on managing accounts or purchases, providing research reports or consultations, etc. Interest income may be generated from credit contribution, debit contribution, short interest rebate, etc. These incomes are considered as revenue generated or associated with the account. An exemplary revenue prediction system according to this disclosure predicts future revenue associated with an account based on historical revenue data associated with the account.

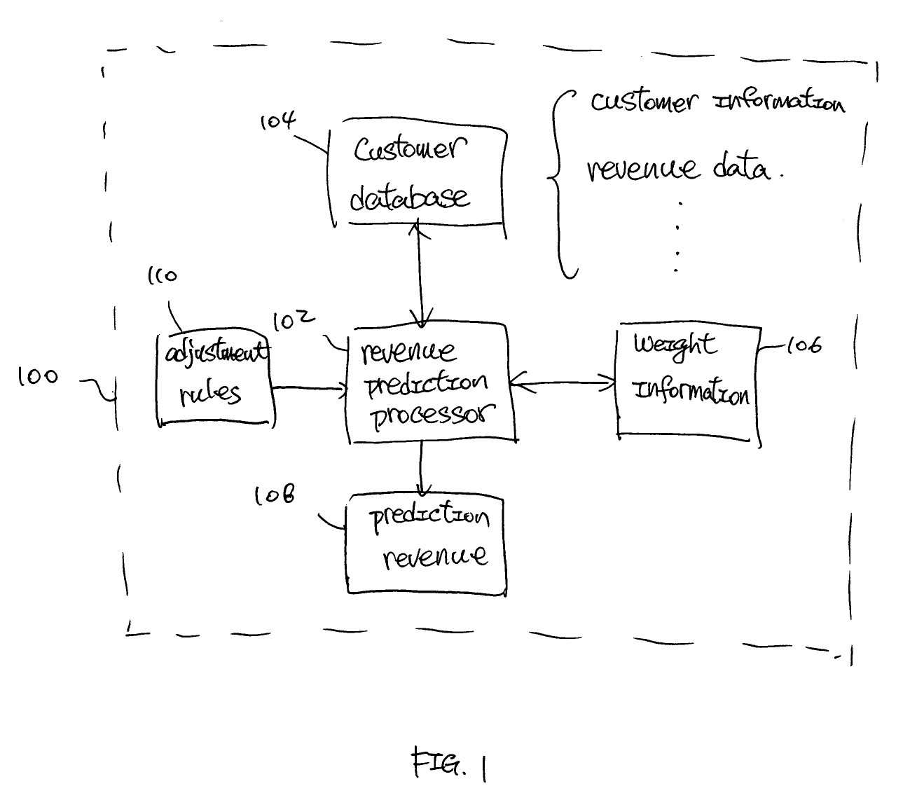

FIG. 1 is a schematic functional block diagram illustrating the operation of an exemplary customer revenue prediction system 100. System 100 includes a revenue prediction process 102 having access to a customer database 104, weight information 106 and adjustment rules 110. Revenue prediction processor 102, customer database 104, weight information 106 and adjustment rules 110 may be implemented on one or more data processing systems, such as a single computer, or a distributed computing system including a plurality of computers with network connections.

Customer database 102 stores various types of data related to a plurality of accounts and/or customers associated therewith. The data may include, but is not limited to, account/customer IDs, assets levels, demographic information, activity histories, profitability status, and/or transaction histories, etc. Customer database 104 provides a data field for storing revenue data to indicate revenue generated and/or associated with each account for specific time periods, such as each month, each quarter or each year. For a new account, the initial value of revenue data may be set to zero.

Revenue prediction processor 102 uses a unique algorithm to predict future revenue corresponding to an account based on historical revenue data stored in customer database 104. In one embodiment, revenue prediction processor 102 uses the following algorithm to determine future revenue of an account:

if account duration is more than 1 year, then

prediction revenue for month X=A×R1+B×R2+C×R3+D×R4+E×R5+F×R6 (a)

wherein:

R1: revenue of the most recent month relative to month X;

R2: revenue of the second most recent month relative to month X;

R3: revenue of the third most recent month relative to month X;

R4: revenue of the fourth most recent month relative to month X;

R5: revenue of the fifth most recent month relative to month X;

R6: revenue of the sixth most recent month relative to month X; and and

A, B, C, D, E and F are predetermined weights corresponding to revenue of each month (the process for determining the respective weight will be discussed shortly).

if account duration is less than 1 year, then

prediction revenue for month X=a×r1+b×r2+b×r3 (b)

wherein:

r1: revenue of the most recent month relative to month X;

r2: revenue of the second most recent month relative to month X;

r3: revenue of the third most recent month relative to month X; and

a, b and c are predetermined weights corresponding to revenue of each month (the process for determining the respective weight will be discussed shortly).

In calculating the prediction revenue for month X, revenue prediction processor 102 obtains revenue data for each month on the right sides of the equations from customer database 104, and the respective weights of each month by accessing weight information 106, and then applies the revenue data and the corresponding weight to equation (a) or (b), depending on the duration of the account for which the prediction is made. For example, in order to predict revenue associated with an account in the upcoming month, say, June 2004, revenue prediction processor 102 accesses customer database 104 for revenue data of six months immediately before June 2004, i.e., May, April, March, February, January 2004, and December 2003, and applies the revenue data to equation (a) to determine prediction revenue of June 2004.

Although the above example uses different equations to calculate prediction revenue for month X based on the account's duration with the brokerage firm, it is not necessary to use different equations to calculate prediction revenue. Rather, it depends on design preference. More or less equations may be used to perform revenue predictions. Furthermore, the number of months used in the equations is not restrictive. Revenue data of more or less number of prior months can be used to predict the revenue of month X.

The prediction revenue calculated by revenue calculation processor 102 may be used to calculate additional prediction revenue for another month or time period. Continuing to the example above, once the prediction revenue for June 2004 is determined, revenue prediction processor 102 may calculate prediction revenue for July 2004 by applying the calculated prediction revenue for June 2004, and historical revenue data for May, April, March, February and January 2004, to equation (a). By performing the same process repeatedly, revenue prediction system 100 is able to predict revenue for any extended period of time. According to one example, revenue prediction system 100 calculates prediction revenue for 12 consecutive months. The sum of the prediction revenue of the 12 months is a prediction of annual revenue associated with the account. After revenue prediction processor 102 determines prediction revenue associated with one or more accounts for a desired time period, such as one or several months, revenue prediction processor 102 may generate a report 108 including the calculated prediction revenue for one or more accounts or customers associated therewith. The report may be implemented as a machine-readable file for access by other data processing systems. For instance, the report may be accessed by a computer in a calling center to discriminate between incoming calls to determine which calls should be answered at a higher priority based on which customer makes the call and how much revenue the customer generates. A preset revenue threshold may be used to identify valuable customers to the brokerage firm: only those customers whose prediction revenue exceeds the preset threshold are given higher levels of services. For example, a phone call made by a first customer with higher revenue should be given a higher priority than a phone call made by a second customer with lower revenue, even though the second customer may have called first.

According to one embodiment, the respective weight corresponding to the revenue data of each month is determined using historical revenue data by performing a empirical process or regression. Regression can be conducted using various types of software applications known to people skilled in the art, such as SAS, EVIEWS, GAUSS, etc. In order to obtain the values of the weights A-F in equation (a), the following regression equation is used:

Ry=A×R1+B×R2+C×R3+D×R4+E×R5+F×R6 (c)

wherein:

Ry is the known revenue associated with an account for a specific proior month Y;

R1: known revenue data of the most recent month relative to month Y;

R2: known revenue data of the second most recent month relative to month Y;

R3: known revenue data of the third most recent month relative to month Y;

R4: known revenue data of the fourth most recent month relative to month Y;

R5: known revenue data of the fifth most recent month relative to month Y;

R6: known revenue data of the sixth most recent month relative to month Y; and

A, B, C, D, E and F are weights to be determined

During the regression process, revenue data retrieved from a known customer pool is fed to regression equation (c), in order to ascertain the respective coefficient (weight) A-G. After the regression process, the values of weights A-G are determined and stored in a data storage device, such as a hard disk, accessible by the revenue prediction system 100. The weights a-c in equation (b) can be determined using a similar approach as described relative to equation (c).

According to one brokerage revenue example, the weights found by the regression for use in equations (a) are:

| Corresponding Month | Weight |
|---|---|
| most recent month R1 | 0.53 |
| second most recent month R2 | 0.16 |
| third most recent month R3 | 0.178 |
| fourth most recent month R4 | 0.123 |
| fifth most recent month R5 | 0.052 |
| sixth most recent month R6 | 0.028 |

and the weights for use in equation (b) are:

| corresponding month | weight |
|---|---|
| most recent month r1 | 0.567 |
| second most recent month r2 | 0.242 |
| third most recent month r3 | 0.189 |

It is understood that the values of the weights are not fixed. Rather, they are generated based on a statistical process, in this example, from processing of actual revenue data. Thus, the exact values of the weights may vary depending on the type and amount of data fed into the regression equations.

According to another embodiment, customer revenue prediction system 100 further adjusts the prediction revenue based on adjustment rules 110 to reflect revenue growth and/or cost of capital or opportunity cost of investments. Adjustment rules may be stored in a data storage device, such as hard disk or data carrying waves, accessible by customer revenue prediction system 100. For instance, after the prediction revenue is calculated, revenue prediction processor 102 multiplies the prediction revenue with an annual growth rate. The growth rate may be set to a widely accepted index or appreciation rate reflecting capital growth. For example, the growth rate may be set as 9.7%, which is the appreciation in common stocks on the S&P index over the period from 1926 to 1997. By applying this growth rate to the prediction revenue, it is assumed that year-to-year growth in revenues will broadly follow this pattern. Furthermore, customer revenue prediction system 100 may apply a discount rate to the prediction revenue to reflect the cost of capital or opportunity cost of investments. The discount rate may be set as 4.48%, which is the 10-year bond rate. Thus, if a prediction of annual prediction revenue associated with an account is R₀, after applying the annual growth rate, the adjusted prediction revenue R₀′=R₀×1.097. R₀′ may be further adjusted by applying the discount rate. Thus, the further adjusted prediction revenue R₀″=R₀′/1.0448=(R₀×1.097)/1.0448. The resulting adjusted prediction revenue can be used to predict revenue for the next year. Continuing the example above, the annual revenue associated with the account is R₀′″=(R₀″×1.097)/1.0448.

After the prediction revenue associated with an account is determined, a prediction of future profits associated with the account also may be determined. For instance, profits associated with an account may be calculated by subtracting an average annual expense associated with the account from the projected annual revenue of the account. The average annual expense of the account may be determined by numerous known approaches, such as dividing total expenses associated with the account by the period of time the account has been in existence.

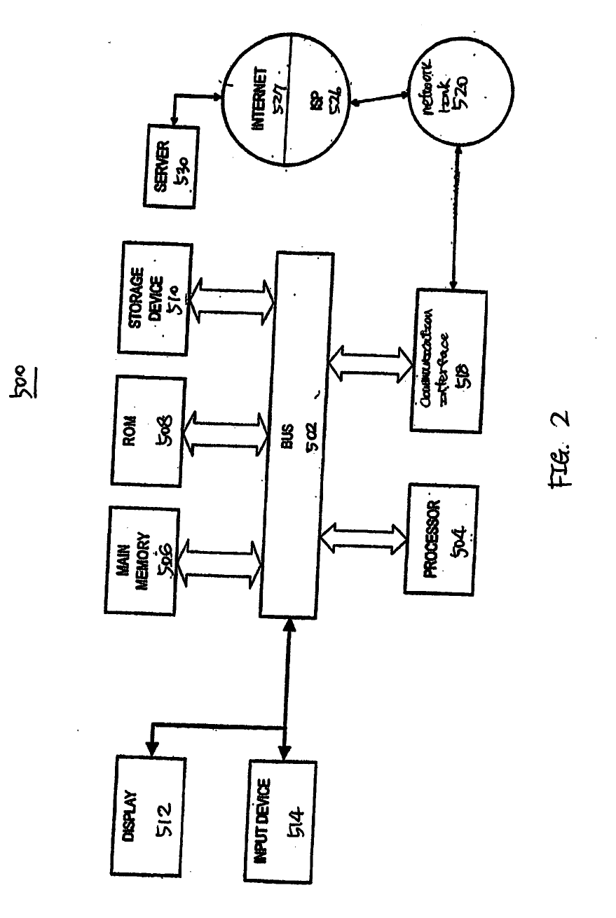

FIG. 2 shows a block diagram of an exemplary data processing system 500 upon which the customer revenue prediction system 100 may be implemented. As discussed earlier, system 100 may be implemented with a single data processing system 500 or a plurality of data processing systems 500 connected by data transmission networks. The data processing system 500 includes a bus 502 or other communication mechanism for communicating information, and a data processor 504 coupled with bus 502 for processing data. The data processing system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by data processor 504. Data processing system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

The data processing system 500 may also have suitable software and/or hardware for converting data from one format to another. An example of this conversion operation is converting format of data available on the system 500 to another format, such as a format for facilitating transmission of the data. The data processing system 500 may be coupled via bus 502 to a display 512, such as a cathode ray tube (CRT), plasma display panel or liquid crystal display (LCD), for displaying information to an operator. An input device 514, including alphanumeric and other keys, is coupled to bus 502 for communicating information and command selections to processor 504. Another type of user input device is cursor control (not shown), such as a mouse, a touch pad, a trackball, or cursor direction keys and the like for communicating direction information and command selections to processor 504 and for controlling cursor movement on display 512.

The data processing system 500 is controlled in response to processor 504 executing one or more sequences of one or more instructions contained in main memory 506. Such instructions may be read into main memory 506 from another machine-readable medium, such as storage device 510 or carrier received via communication interface 518. Execution of the sequences of instructions contained in main memory 506 causes processor 504 to perform the process steps described herein.

In one embodiment, revenue prediction processor 102 is implemented by processor 504 under the control of suitable instructions stored in storage device 510. For instance, under the control of pre-stored instructions, the data processor 504 accesses customer data stored in customer database 104, weight information 106 and adjustment rules 110 stored in the data storage device 510 and/or other data storage device coupled to the data processing system, and calculates the prediction revenue of one or more accounts. In alternative embodiments, hard-wired circuitry may be used in place of or in combination with software instructions to implement the disclosed calculations. Thus, the embodiments disclosed herein are not limited to any specific combination of hardware circuitry and software.

The term “machine readable medium” as used herein refers to any medium that participates in providing instructions to processor 504 for execution or providing data to the processor 504 for processing. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502 or an external network. Transmission media can also take the form of acoustic or light waves, such as those generated during radio wave and infrared data communications, which may be carried on the links of the bus or external network.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 504 for execution. For example, the instructions may initially be carried on a magnetic disk of a remote data processing system, such as a server. The remote data processing system can load the instructions into its dynamic memory and send the instructions over a telephone line using a modem. A modem local to data processing system 500 can receive the data on the telephone line and use an infrared transmitter to convert the data to an infrared signal. An infrared detector can receive the data carried in the infrared signal, and appropriate circuitry can place the data on bus 502. Of course, a variety of broadband communication techniques/equipment may be used for any of those links. Bus 502 carries the data to main memory 506, from which processor 504 retrieves and executes instructions and/or processes data. The instructions and/or data received by main memory 506 may optionally be stored on storage device 510 either before or after execution or other handling by the processor 504.

Data processing system 500 also includes a communication interface 518 coupled to bus 502. Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a wired or wireless local area network (LAN) card to provide a data communication connection to a compatible LAN. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network to data equipment operated by an Internet Service Provider (ISP) 526. ISP 526 in turn provides data communication services through the world wide packet data communication network now commonly referred to as the Internet 527. Local ISP network 526 and Internet 527 both use electrical, electromagnetic or optical signals that carry digital data streams. The signals through the various networks and the signals on network link 520 and through communication interface 518, which carry the digital data to and from data processing system 500, are exemplary forms of carrier waves transporting the information.

The data processing system 500 can send messages and receive data, including program code, through the network(s), network link 520 and communication interface 518. In the Internet example, a server 530 might transmit a requested code for an application program through Internet 527, ISP 526, local network and communication interface 518. The program, for example, might implement prediction of customer revenue, as outlined above. The communications capabilities also allow loading of relevant data into the system, for processing in accord with this disclosure.

The data processing system 500 also has various signal input/output ports for connecting to and communicating with peripheral devices, such as printers, displays, etc. The input/output ports may include USB port, PS/2 port, serial port, parallel port, IEEE-1394 port, infra red communication port, etc., and/or other proprietary ports. The data processing system 500 may communicate with other data processing systems via such signal input/output ports.

The system and method as discussed herein may be implemented using a single data processing system, such as a single PC, or a combination of a plurality of data processing systems of different types. For instance, a client-server structure or distributed data processing architecture can be used to implement the system disclosed herein, in which a plurality of data processing systems are coupled to a network for communicating with each other. Some of the data processing systems may serve as servers handling data flow, providing calculation services or access to customer data, and/or updating software residing on other data processing systems coupled to the network.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall there-between.

What is claimed is:

1. A method for predicting revenue associated with an account, comprising the steps of:
(a) selecting a specific time period for predicting revenue thereof;
(b) selecting a predetermined number of time periods prior to the specific time period;
(c) accessing revenue data of each of the prior time periods;
(d) assigning a weight to the revenue data of each of the respective prior time period, wherein each weight is selected based on the recentness of respective prior time period relative to the specific time period; and
(e) calculating prediction revenue of the specific time period based on the revenue data and the weight of each of the prior time periods.

2. The method of claim 1 further comprising a step of generating adjusted prediction revenue for the specific time period by applying a predetermined adjustment rule to the prediction revenue.

3. The method of claim 2, wherein the adjustment rule includes applying a growth rate.

4. The method of claim 2, wherein the adjustment rule further includes applying a discount rate.

5. The method of claim 1, wherein the prior time periods includes a time period immediately before the specific time period.

6. The method of claim 1, wherein specific time period and each of the prior time periods are of the same length.

7. The method of claim 1 further including a step of performing step (a) through step (e) repeatedly to predict revenue of a plurality of specific time periods.

8. The method of claim 7, wherein the specific time period is a month and the plurality of specific time periods comprises eleven months.

9. The method of claim 8 further comprising a step of calculating annual prediction revenue associated with the account by accumulating the prediction revenue of each of the plurality of specific time periods.

10. The method of claim 9 further comprising a step of generating adjusted annual prediction revenue by applying a predetermined adjustment rule to the annual prediction revenue.

11. The method of claim 10, wherein the adjustment rule includes applying a growth rate.

12. The method of claim 10, wherein the adjustment rule further includes applying a discount rate.

13. The method of claim 1 further including a step of determining a service level of a customer associated with the account based on the prediction revenue associated with the account.

14. A data processing system for predicting revenue associated with an account, comprising:
a processor for processing data;
a data storage device coupled to the processor;
the data storage device bearing instructions to cause the data processing system to perform the steps of:
(a) selecting a specific time period for predicting revenue thereof;
(b) selecting a predetermined number of time periods prior to the specific time period;
(c) accessing revenue data of each of the prior time periods;
(d) assigning a weight to the revenue data of each of the respective prior time period, wherein each weight is selected based on the recentness of respective prior time period relative to the specific time period; and
(e) calculating prediction revenue of the specific time period based on the revenue data and the weight of each of the prior time periods.

15. The system of claim 14, wherein the data storage device further bears instructions to cause the data processing system to perform a step of generating adjusted prediction revenue for the specific time period by applying a predetermined adjustment rule to the prediction revenue.

16. The system of claim 15, wherein the adjustment rule includes applying a growth rate.

17. The system of claim 15, wherein the adjustment rule further includes applying a discount rate.

18. The system of claim 14, wherein the prior time periods includes a time period immediately before the specific time period.

19. The system of claim 14, wherein specific time period and each of the prior time periods are of the same length.

20. The system of claim 14, wherein the data storage device further bears instructions to cause the data processing system to perform step (a) through step (e) repeatedly to predict revenue of each of a plurality of specific time periods.

21. The system of claim 20, wherein the specific time period is a month and the plurality of specific time periods comprises eleven months.

22. The system of claim 21, wherein the data storage device further bears instructions to cause the data processing system to perform a step of calculating annual prediction revenue associated with the account by accumulating the prediction revenue of each of the plurality of specific time periods.

23. The system of claim 22, wherein the data storage device further bears instructions to cause the data processing system to perform a step of generating adjusted annual prediction revenue by applying a predetermined adjustment rule to the annual prediction revenue.

24. The system of claim 23, wherein the adjustment rule includes applying a growth rate.

25. The system of claim 23, wherein the adjustment rule further includes applying a discount rate.

26. The system of claim 14, wherein the data storage device further bears instructions to cause the data processing system to perform a step of determining a service level of a customer associated with the account based on the prediction revenue associated with the account.

27. A program comprising instructions, which may be embodied in a machine-readable medium, for controlling a data processing system to predict revenue associated with an account, the instructions upon execution by the data processing system causing the data processing system to perform the steps as in the method of claim 1.

28. The program of claim 27 further comprising instructions to cause the data processing program to perform a step of generating adjusted prediction revenue for the specific time period by applying a predetermined adjustment rule to the prediction revenue.

29. The program of claim 28, wherein the adjustment rule includes applying a growth rate.

30. The program of claim 28, wherein the adjustment rule further includes applying a discount rate.

31. The program of claim 27, wherein the prior time periods includes a time period immediately before the specific time period.

32. The program of claim 27, wherein the specific time period and each of the prior time periods are of the same length.

33. The program of claim 27 further comprising instructions to cause the data processing program to perform step (a) through step (e) repeatedly to predict revenue of each of a plurality of specific time periods.

34. The program of claim 33, wherein the specific time period is a month and the plurality of specific time periods comprises eleven months.

35. The program of claim 34 further comprising instructions to cause the data processing program to perform a step of calculating annual prediction revenue associated with the account by accumulating the prediction revenue of each of the plurality of specific time periods.

36. The program of claim 35 further comprising instructions to cause the data processing program to perform a step of generating adjusted annual prediction revenue by applying a predetermined adjustment rule to the annual prediction revenue.

37. The program of claim 36, wherein the adjustment rule includes applying a growth rate.

38. The program of claim 36, wherein the adjustment rule further includes applying a discount rate.

39. The program of claim 27 further comprising instructions to cause the data processing program to perform a step of determining a service level of a customer associated with the account based on the prediction revenue associated with the account.
